(19) United States
(12) Patent Application Publication
(10) Pub. No.: US 2009/0097638 A1
(43) Pub. Date: Apr. 16, 2009

(54) INFORMATION PROCESSING APPARATUS

(75) Inventor: Teruaki Uehara, Kanagawa (JP)

Correspondence Address: VOLENTINE & WHITT PLLC, ONE FREEDOM SQUARE, 11951 FREEDOM DRIVE SUITE 1260, RESTON, VA, 20190, US

(73) Assignee: Oki Electric Industry Co., Ltd., Tokyo (JP)

(21) Appl. No.: 12/205,994

(22) Filed: Sep. 8, 2008

(30) Foreign Application Priority Data
Oct. 16, 2007 (JP) 2007268638

(51) Int. Cl. H04L 9/06

(52) U.S. Cl. 380/29

(57) ABSTRACT

Three registers are provided in an input register section and each register stores 8 bytes of input packet data upon performing an encryption process or an authorization value creation process on input packet data. Creation of an authorization value using a first EXOR circuit and an AES circuit is performed on the data stored in the first two registers. Then, encryption is performed on the input packet data using the first EXOR circuit and the AES circuit on the data stored in the last two registers. The encrypted data is stored in the last two registers, then the data in the input register section are shifted by 16 bytes. The 16 bytes of data that are a continuation of the input packet data and are repeatedly stored in the last two registers.

### CROSS-REFERENCE TO RELATED APPLICATION

This application claims priority under 35 USC 119 from Japanese Patent Application No. 2007-268638, the disclosure of which is incorporated by reference herein.

### BACKGROUND OF THE INVENTION

1. Field of the Invention

The present invention relates to an information-processing apparatus that performs encryption and authorization used in IPsec. Specifically, the present invention relates to an information-processing apparatus that performs AES-CTR encryption, AES-CBC encryption and XCBC authorization value creation, using AES algorithms.

2. Description of the Related Art

The importance of security is widely recognized in Internet communication. Various methods for realizing confidentiality of communication (i.e., prevention of content being known by a monitoring party) and legitimacy of communication (i.e., making sure the content is not changed in route) have been proposed.

An example of a conventional technology relating to the encryption and authorization of data can be found in Japanese Patent Application (JP-A) Laid-Open No. 2005-110223. Here, a technology is proposed where an encryption key can be easily updated. When the initial vector outputted from a converter and the initial vector obtained during reception of the signal are the same, it is determined that the encryption key obtained after is the same as that of the sending device.

In addition, with regard to the data sending method disclosed in JP-A No. 2005-110223, when it has been determined that the encryption key is that of the sending device, the initial vector outputted from the converter is supplied to an encryption unit as the first word. An encryption key from the storage section of the encryption unit is used for encryption and a part of the output from the encryption unit is returned to a register and is converted into the next word using a publicly known output feedback (OFB). Meanwhile, the output of the encryption unit is supplied to an addition unit as an encryption key, and decryption of a received signal from a synchronized detection unit is performed.

In the JP-A No. 10-233771, a proposal is made where authorization is performed using authorization data that is double the length of conventional data, in order to increase the safety of a mechanized authentication system.

Specifically, a random number of 64 bits is first generated at the authorization device and the random number is sent to the device to be authorized. The random number is divided by the authorizing device and the device to be authorized into two 32-bit data each, and one of those obtained data is converted into a key for the other data in the devices. Then, the device to be authorized sends the result of the conversion to the authorizing device. Next, the authorizing device performs authorization by comparing the conversion result received from the device to be authorized with its own conversion result.

There are cases where Security Architecture for Internet Protocol (IPsec) is applied as a method for realizing confidentiality and legitimacy of the above-described communication.

IPsec is realized with an encryption algorithm and certification algorithm. For the encryption algorithm, Data Encryption Standard (DES) and triple DES were used conventionally.

In recent years, since problems were found in the safety of DES, it is predicted that Advanced Encryption Standard (AES) will become commonly in use for encryption algorithms in the future.

Secure Hash Algorithm-1 (SHA-1) and Message Digest algorithm-5 (MD-5) are the authorization algorithms that are used conventionally. However, like DES, since weaknesses have been found therewith, it is predicted that an XCBC method based on AES algorithms will become commonly used in the future.

However, in conventional technologies, when using AES algorithms and performing encryption and authorization, separate circuits were provided for executing encryption and for executing authorization. This causes the scale of the circuits to be increased.

When performing encryption and authorization value creation with an information processing circuit, it is assumed that processing for creating an authorization value will be performed by: performing sequential encryption on one-packet portions of data inputted to the information processing circuit; accumulating the sequential output in a buffer memory; switching the circuit configuration; and performing an authorization value creation process based on the one-packet portions of encrypted data accumulated in the buffer memory. In this case, it is necessary to prepare the buffer memory to have a capacity that can store a one-packet portion of data. However, since a one-packet portion of data may include 2 Kbytes to 10 Kbytes of data, when performing encryption and authorization value creation with an information processing circuit, the scale of the circuitry may increase.

### SUMMARY OF THE INVENTION

The present invention is to provide an information-processing apparatus that can execute encryption and authorization value creation without requiring an increase in the scale of the circuit.

A first aspect of the invention is an information processing apparatus that performs an encryption process and an authorization value creation process on input packet data, including: a first EXOR circuit that outputs EXOR values for two pieces of data; an encryption circuit that block encrypts the output of the EXOR circuit, in a predetermined block unit, based on preset key data; an input register section including 3m/2 registers (where m is an even number) that stores the input packet data in 1/m block units; and a control section that controls to continually execute the processes of: an authorization value creation process that creates an authorization value for the input packet data stored in the first m registers of the input register using the first EXOR circuit and the encryption circuit; an encryption process that encrypts the input packet data stored in the last m registers of the input register using the first EXOR circuit and the encryption circuit; storing the encrypted data encrypted by the encryption process in the last m registers of the input register section, shifting the data of the input register by m registers; and storing continuation data of the input packet in the last m registers of the input register section.

A second aspect of the invention is an information processing apparatus that performs an encryption process and an authorization value creation process on input packet data, including: a first EXOR circuit that outputs EXOR values for two pieces of data; an encryption circuit that block encrypts the output of the EXOR circuit, in a predetermined block unit, based on preset key data; an input register section that stores the input packet data in one-block portions; and a control section that controls to continually execute the processes of: an authorization value creation process that creates an authorization value for the input packet data stored in the input register using the first EXOR circuit and the encryption circuit; an encryption process that encrypts the input packet data stored in the input register using the first EXOR circuit and the encryption circuit; storing the encrypted data encrypted by the encryption process in the input register section; and storing one-block portions of continuation data of the input packet in the input register.

A third aspect of the invention is an information processing apparatus that performs an encryption process and an authorization value creation process on input packet data, including: a first EXOR circuit that outputs EXOR values for two pieces of data; an encryption circuit that block encrypts the output of the EXOR circuit, in a 16-byte block unit, based on preset key data; an input register section including three registers that store the input packet data, with one 8-byte portion per register; and a control section that controls selectively to execute one of: a CBC mode, in which the control section controls to continually execute: an authorization value creation process that creates an authorization value for the input packet data stored in the first two registers of the input register using the first EXOR circuit and the encryption circuit; an encryption process that encrypts the input packet data stored in the last two registers of the input register using the first EXOR circuit and the encryption circuit; storing the encrypted data encrypted by the encryption process in the last two registers of the input register; and shifting the data of the input register by a two-register portion and storing two-block portions of continuations of the input packet data in the last two registers; or a CTR mode, in which the control section controls to continually execute: an encryption process that encrypts the input packet data stored in the first two registers of the input register by using the first EXOR circuit and the encryption circuit; storing the encrypted data encrypted by the encryption process in the first two registers of the input register section; an authorization value creation process that creates an authorization value for the encrypted data stored in the first two registers of the input register by using the first EXOR circuit and the encryption circuit; shifting the data of the input register by two register portions; and storing continuation data of the input packet data in the last two register portions.

In the above-described aspects, the information-processing apparatus may further include a second EXOR circuit that outputs EXOR values for two pieces of data, wherein the control section may further execute a decryption process that decrypts the encrypted input packet data by using the first EXOR circuit and the second EXOR circuit alternately. The above-described aspects may also include the second EXOR circuit arranged at the output end of the encryption circuit.

As explained above, encryption and authorization value creation can be executed without increasing the scale of the circuit.

### BRIEF DESCRIPTION OF THE DRAWINGS

Exemplary embodiments of the present invention will be described in detail based on the following figures, wherein:

FIG. 1 is a block diagram showing the overall configuration of an information processing circuit according to the present exemplary embodiment;

FIG. 2A is a frame format showing the configuration of a packet encrypted in AES-CBC mode;

FIG. 2B is a frame format showing the configuration of a packet encrypted in AES-CTR mode;

FIG. 3 is a block diagram showing the detailed configuration of a work register of an information processing circuit according to the embodiment;

FIG. 4 is a flowchart showing the flow of an encrypted authorization value creation process with AES-CBC mode used in the information processing circuit according to the embodiment;

FIG. 5 is a flowchart showing the flow of a decrypted authorization value creation process with AES-CBC mode used in the information processing circuit according to the embodiment;

FIG. 6 is a flowchart showing the flow of an encrypted authorization value creation process with AES-CTR mode used in the information processing circuit according to the embodiment;

FIG. 7 is a flowchart showing the flow of a decrypted authorization value creation process with AES-CTR mode used in the information processing circuit according to the embodiment;

FIG. 8 is a block diagram showing the flow of the data when generation of a work key and storage thereof are performed by the information processing circuit according to the embodiment;

FIG. 9 is a block diagram showing the flow of data when storing IV in a work register according to the embodiment in AES-CBC mode;

FIG. 10 is a block diagram showing the flow of data when creating an authorization value by the information processing circuit according to the embodiment;

FIG. 11 is a block diagram showing the flow of data when performing encryption with AES-CBC mode by the information processing circuit according to the embodiment;

FIG. 12 is a block diagram showing the flow of data when performing decryption with AES-CBC mode by the information processing circuit according to the embodiment;

FIG. 13 is a block diagram showing the flow of data when storing IV in a work register according to the embodiment in AES-CTR mode;

FIG. 14 is a block diagram showing the flow of data when performing encryption with AES-CTR mode by the information processing circuit according to the embodiment;

FIG. 15 is a block diagram showing the flow of data when outputting data stored in an IV_reg in a work register according to the embodiment in AES-CTR mode;

FIG. 16 is a block diagram showing the flow of data when performing decryption with AES-CTR mode by the information processing circuit according to the embodiment; and

FIG. 17 is a block diagram showing the flow of data when executing processing using a work key K3 upon performing XCBC processing by the information processing circuit according to the embodiment.

### DETAILED DESCRIPTION OF THE INVENTION

Hereafter, embodiments of the present invention will be described in detail with reference to the drawings. Note that, in the present embodiment, explanations will be given for a case where the present invention is applied in IP communication to an IPsec device where Security Architecture for Internet Protocol (IPsec) is in use. In these explanations, Encapsulating Security Payload (ESP) is used for IPsec security protocol.

In addition, with the present embodiment, explanations will be given for a case where an Advanced Encryption Standard (AES) that encrypts data in units of 128-bit blocks (with encryption algorithms as the block-encrypting method) is applied; and where XCBC is applied as the authorization algorithm.

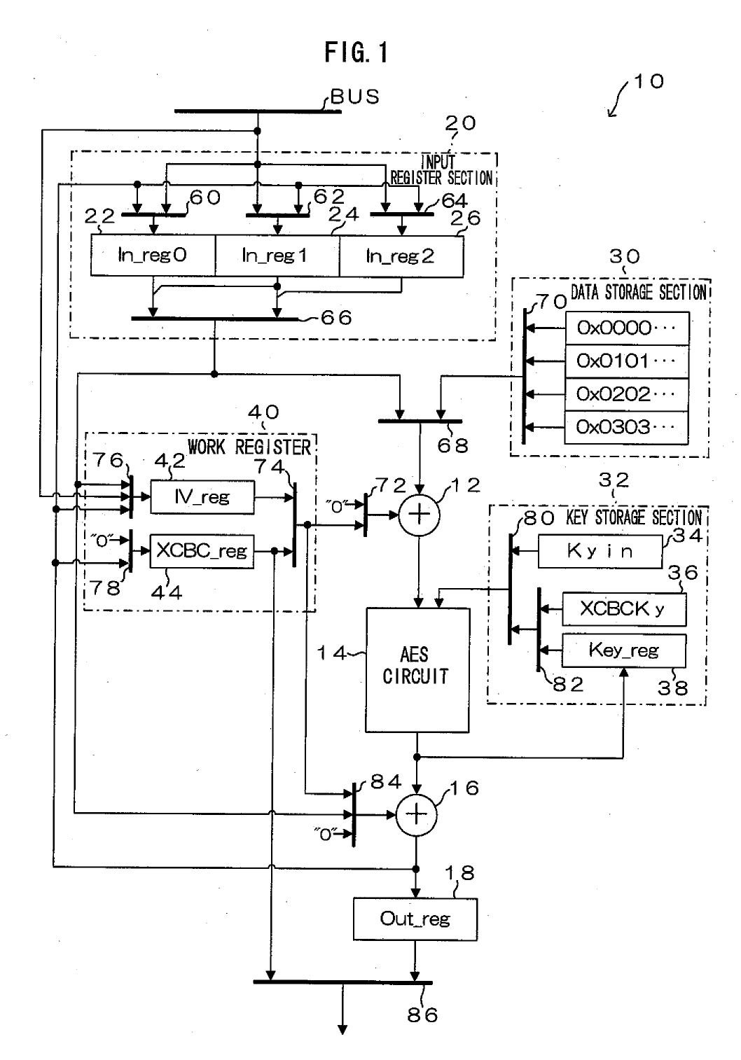

FIG. 1 is an outline diagram showing the configuration of an information processing circuit 10 according to the present embodiment. Note that, the information processing circuit 10 shown in FIG. 1 is the part of the circuitry in an IPsec device that executes encryption process, decryption process, and authorization value creation process.

As shown in FIG. 1, the information processing circuit 10 is configured to include a first exclusive disjunction circuit (EXOR) circuit 12, an AES circuit 14, and a second EXOR circuit 16. The output end of the first EXOR circuit 12 is connected to the input end of the AES circuit 14. The output end of the AES circuit 14 is connected to the input end of the second EXOR circuit 16.

Note that in FIG. 1, the components numbered 60, 62, 64, 66, 68, 70, 72, 74, 76, 78, 80, 82, 84, and 86 are selectors, and the data inputted into each selector can be selectively outputted. Each selector is operated based on a control signal, outputted from a control circuit (not shown) to each selector. For example, each selector selects data and outputs the data based on the timing of when the control signal is inputted.

The information processing circuit 10 also includes an output register section (Out_reg) 18, an input register section 20, a data storage section 30, a key storage section 32, and work register 40, to temporarily store data used in each circuit or data outputted from each circuit.

The computation result of each above-described computing circuit provided in the information processing circuit 10 is inputted to the output register section 18, and the computation result is retained temporarily. The output register section 18 is connected to the outside of the information processing circuit 10 through the selector 86.

The input register section 20 is connected to a BUS that is connected to a control section (not shown) that controls the operation of the entire IPsec device, and is configured to input the IP packets received from the outside of the information processing circuit 10. Further, the input register section 20 is connected to the first EXOR circuit 12 via the selector 68. Note that, the input register section 20 is connected to the second EXOR circuit 16 through the selector 84. Furthermore, the input end of the input register section 20 is connected to the output end of the second EXOR circuit 16.

The input register section 20 consists of three registers 22, 24, and 26 of the same capacities of In_reg0, In_reg1, and In_reg2. Each input end of each register 22, 24, and 26 is provided with the selectors 60, 62, and 64 respectively. Accordingly, either one of an IP packet inputted through the BUS or a computation result outputted from the output end of the second EXOR circuit 16 is selectively inputted into each register 22, 24, and 26 through each selector 60, 62, and 64.

Four pieces of data of predetermined length are stored in the data storage section 30. Also, the selector 70 is provided at the output end of the data storage section 30. The data stored in the data storage section 30 is selectively outputted by the selector 70. Note that, three of the four pieces of data stored in the data storage section 30 are data of patterns that comply with IPsec standards, and the remaining one is data equivalent to “0”.

Further, the data storage section 30 is connected to the first EXOR circuit 12 through the selector 68. The selector 68 selectively inputs data stored in the input register section 20 and the data storage section 30, into the first EXOR circuit 12.

The key storage section 32 is configured to include three registers, a Kyin 34 where an encryption key is held, a XCBCKy 36 where an authorization key is held, and a Key_reg 38 where a work key is held. The Kyin 34 is connected to the AES circuit 14 through the selector 80. The XCBCKy 36 and Key_reg 38 are connected to the AES circuit 14 through the selector 82 and the selector 80.

Note that, when the AES circuit 14 is used for encryption and decryption, the encryption key held by the Kyin 34 is inputted into the AES circuit 14. Also, when the AES circuit 14 is used for generation of a work key, the authorization key held by the XCBCKy 36 is inputted into the AES circuit 14. When the AES circuit 14 is used for creating the authorization value, a work key held by the Key_reg 38 is inputted into the AES circuit 14.

The work register 40 is configured to include a IV_reg 42 and a XCBC_reg 44. The IV_reg 42 and XCBC_reg 44 are connected to the first EXOR circuit 12 through the selector 74 and selector 72 respectively. Note, the selector 76 is provided at the input end of the IV_reg 42 and the selector 76 is also selectively connected to either the BUS, the output end of the selector 66, or the output end of the second EXOR circuit 16. Meanwhile, the selector 78 is provided at the input end of XCBC_reg 44, and either “0” or the computation result outputted from the second EXOR circuit 16 is selectively inputted.

When encryption and decryption are carried out in the information processing circuit 10, the selector 74 outputs the data stored in the IV_reg 42. Note that, when an authorization value creation is executed in the information processing circuit 10, the data stored in the XCBC_reg 44 is outputted.

Also, when the first EXOR circuit 12 is made to function (i.e., when computing the exclusive disjunction), the selector 72 selects the output of the selector 74. On the other hand, when the first EXOR circuit 12 is not made to function (i.e., when inputting the output from the selector 68 directly into the AES circuit 14), the selector 72 selects “0”.

Note that, the output end of the work register 40 is connected to the selector 84. Furthermore, the output end of the XCBC_reg 44 is connected to the selector 86.

When the second EXOR circuit 16 is made to function (i.e., when computing exclusive disjunction), the selector 84 selects the output of the selector 74 or the output of the selector 66. On the other hand, when the second EXOR circuit 16 is not made to function (i.e., when using or outputting the computation result of the AES circuit 14 directly), the selector 84 selects “0”.

Here, the information processing circuit 10 according to the present embodiment is configured to handle both cipher block AES-CBC (chaining) and AES-CTR (counter).

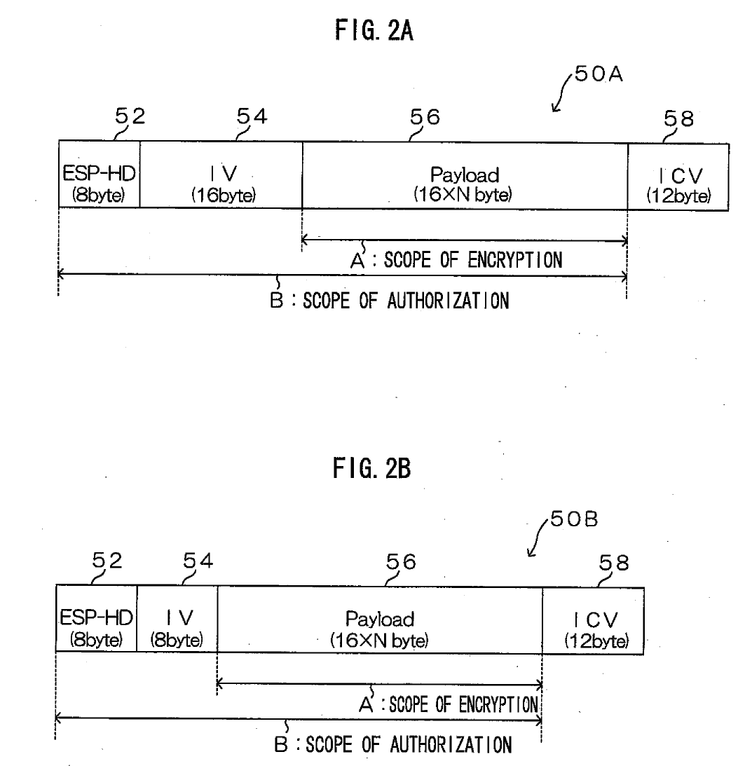

An example of the structure of a packet 50A made IPsec with AES-CBC is shown in FIG. 2A. As shown in FIG. 2A, the packet 50A includes a ESP header (ESP-HD) 52, an initialization vector (IV) 54, a payload 56, and an authorization value (ICV: integrity check value) 58.

The ESP header 52 is 8 bytes of data that shows the IPsec parameters decided by negotiation prior to packet transmission and reception between IPsec devices. The parameters include an encryption key, an authorization key, and AES mode.

Also, the IV 54 is a data having the same length of the block length, block encrypted by AES, at 128 bits (equals to 16 bytes), and is used for the encryption and decryption the first block of payload 56 in a CBC mode. In other words, in the CBC mode, data Dn of block n to be encrypted and the exclusive disjunction (Dn exor dn−1) with the encrypted data dn−1, from encrypting the previous block n−1, are AES encrypted using an encryption key, and are turned into encrypted data dn of the block n (where, dn is AES encryption key (Dn exor dn−1)). In encrypting and decrypting the first block, since a previous block does not exist, the data of the first block is encrypted via an exclusive disjunction with IV 54 (d1, or AES encryption key (D1exor IV)).

The payload 56 is an encrypted data having a length of N times 16 bytes. In other words, when encrypting in AES and the last block does not fulfill 128 bits, data is added to the end of the last block so to become 128 bits, after encryption is performed. For this reason, in AES, regardless of the type of data being encrypted, the length of the data becomes N times 16 bytes.

The ICV 58 is 12-byte long data and is the authorization value derived by XCBC.

In FIG. 2B, an example of the configuration of the packet 50B made IPsec in AES-CTR is shown. As shown in FIG. 2B, the packet 50B has the same configuration as the packet 50A with the above-described AES-CBC, except that the IV 54 is 8 bytes. In other words, with AES-CTR, the exclusive disjunction of 16 bytes of CTRn data (comprising, e.g., a random number (nonce) of 4 bytes set in advance by negotiation, IV 54 of 8 bytes, and a count value n of 4 bytes set by the counter) and the data Dn of a block n of the payload is encrypted (dn=AES encryption key (CTRN exor Dn)).

Here, with the information processing circuit 10 according to the present embodiment, the configuration of the IV_reg 42 of the work register 40 is made to handle both AES-CBC and AES-CTR.

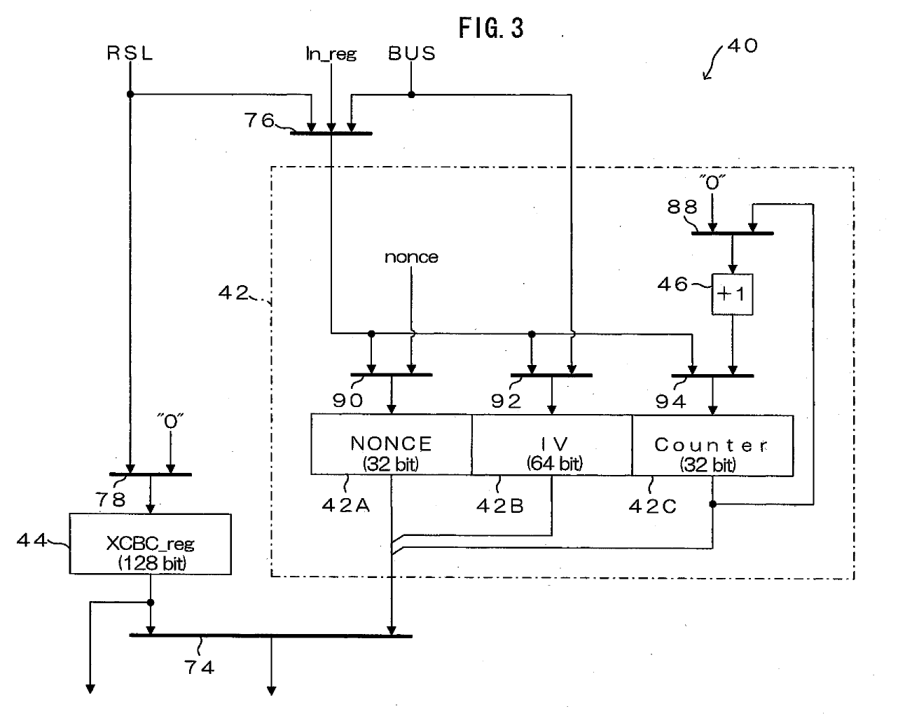

A detailed configuration drawing of the work register 40 is shown in FIG. 3. As shown in FIG. 3, the IV_reg 42 is configured into three blocks 42A, 42B, and 42C. Each output end of the blocks 42A, 42B, and 42C is connected to the selector 74. Therefore, the data in each of the blocks 42A, 42B, and 42C are together and read out as one line of data.

The IV_reg 42 is 8 bytes that corresponds with the data length of the encrypting block. Within the IV_reg 42, the NONCE block 42A is made 32 bits in accordance with the data length of a random number when executing ABS-CTR. The IV block 42B is set to 64 bits in accordance with the data length of the IV 54 of AES-CTR. The remaining 32 bits are assigned to counter block 42C.

The selectors 90, 92, 94 are provided at each input end of the blocks 42A, 42B, and 42C. As with the above-described selectors, the blocks 42A, 42B, and 42C are controlled in accordance with the operation status of the information processing circuit 10. Besides the data inputted through the selector 76, a random number, IV, and count value are also inputted to each of the selectors 90, 92, and 94.

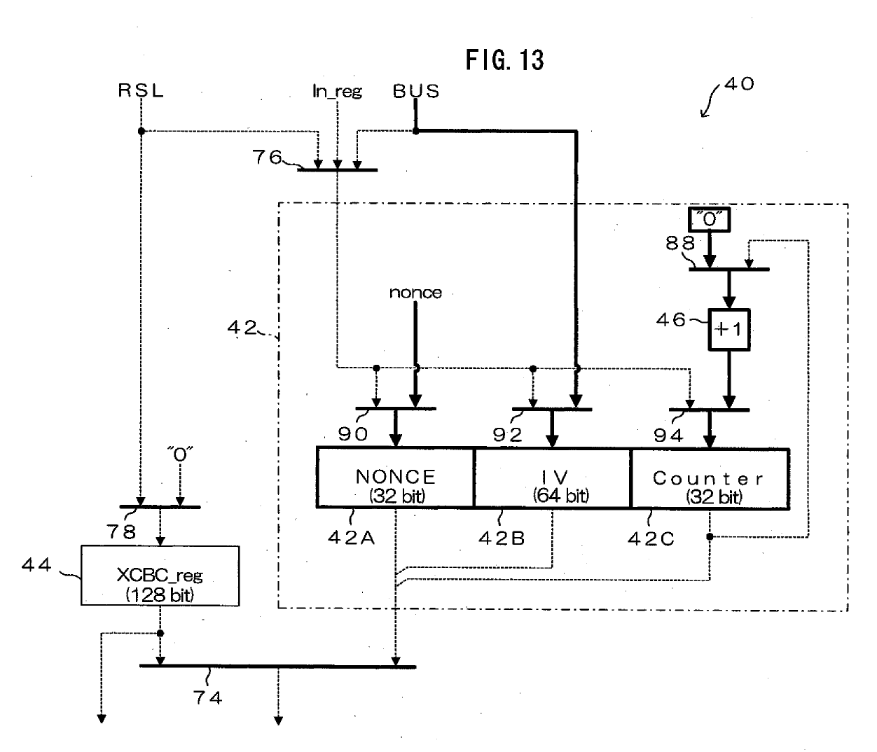

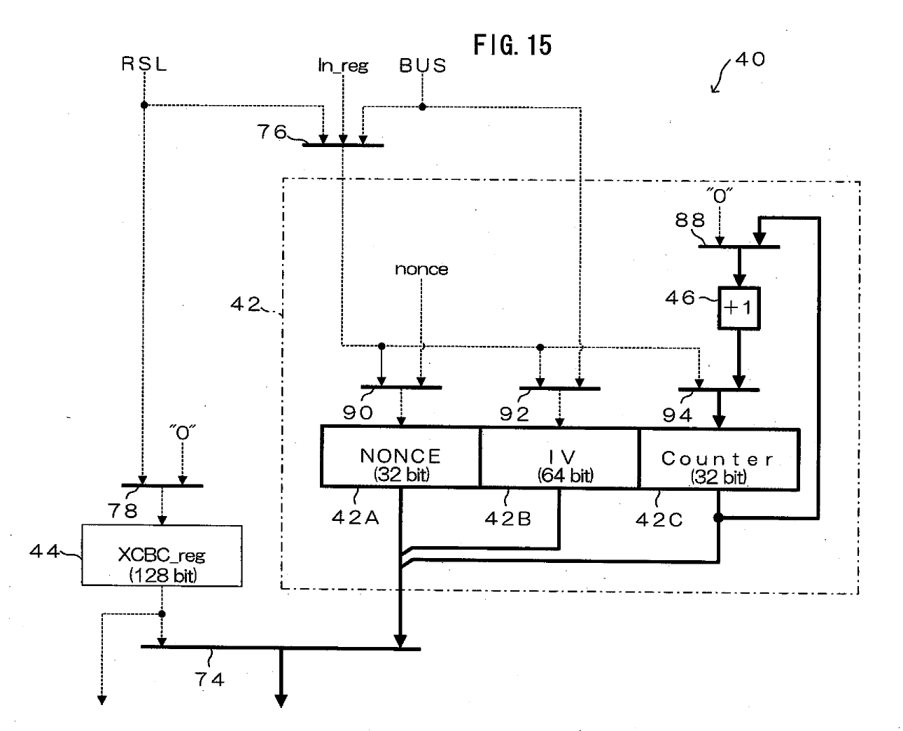

Furthermore, the output end of the counter block 42C is connected to the input end of a count-up container 46 via a selector 88, and the output end of the count-up device 46 is connected to the counter block 42C through the selector 94. A count value of the counter block 42C is up counted each time when the encryption of one block is completed. Note that, the count value of the counter block 42C is initialized by the outputting of “0” by the selector 88 (refer also to FIGS. 13 and 15).

When executing AES-CBC encryption, the 16-byte IV 54 is inputted to the IV_reg 42 across the blocks 42A, 42B, and 42C at the time processing is initiated. Then, each time encryption of one block is completed, the IV_reg 42 is replaced with encrypted data dn.

Further, when carrying out AES-CBC decryption, a 16-byte IV 54 is inputted to the IV_reg 42 across the blocks 42A, 42B, and 42C at the time when processing is initiated. Each time the decryption to each block n is completed, the pre-decrypted data of the decrypted block n is replaced.

Hereafter, the operation of the present embodiment will be explained.

The information processing circuit 10, according to the present embodiment, is used for encryption and an authorization value creation, when sending or receiving packets by IP communication using IPsec. The operations of the information processing circuit 10, according to the present embodiment, are controlled by a control circuit (not shown) in accordance with the encryption mode of the sent or received packet.

Note that, the information processing circuit 10 according to the present embodiment can handle two types of encryption mode, AES-CBC and ABS-CTR. Therefore, explanations below will be made distinguishing between modes, encryption and decryption processing.

### [AES-CBC Mode Encryption/Authorization Value Creation]

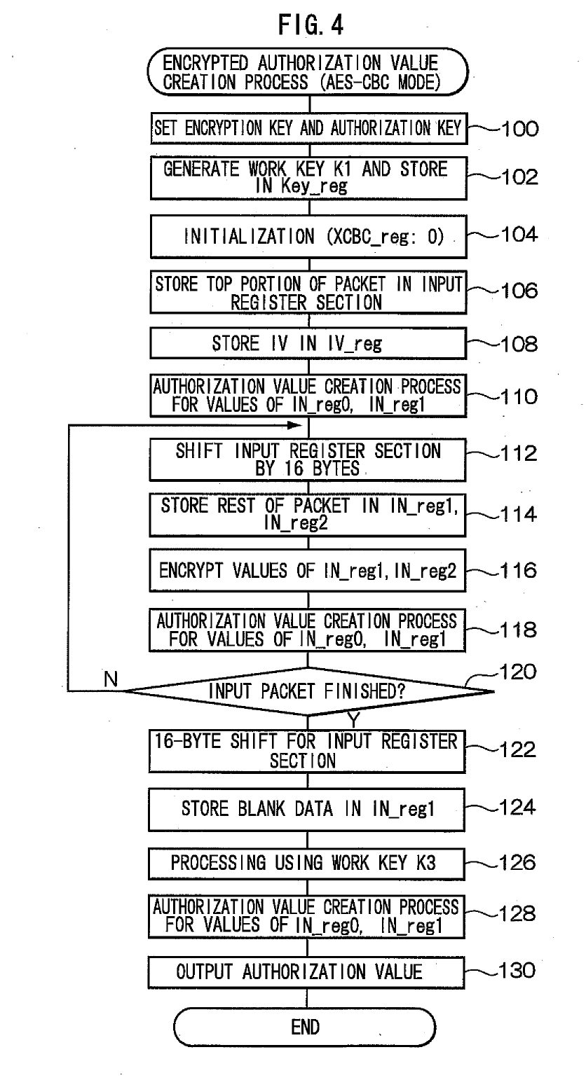

The flow of processing using the information processing circuit 10 when encrypting a packet with AES-CBC mode is shown in FIG. 4 as a flowchart. Hereafter, the operations of encryption and authorization value creation with the AES-CBC mode by the information processing circuit 10 according to the present embodiment will be explained.

First, as shown in step 100, the encryption key and authorization key that should be applied to this processing are in set. The encryption key and the authorization key are in set by negotiation with the IPsec device to be communicated with the IPsec device in which the information processing circuit 10 is built into. The encryption key and the authorization key are respectively inputted and set in the KCBCKy 36 and the Kyin 34.

At the next step 102, generation of a work key K1 used in the authorization value creation (XCBC), and storage of the work key K1 to the Key_reg 38 are performed. Then, the process moves to step 104.

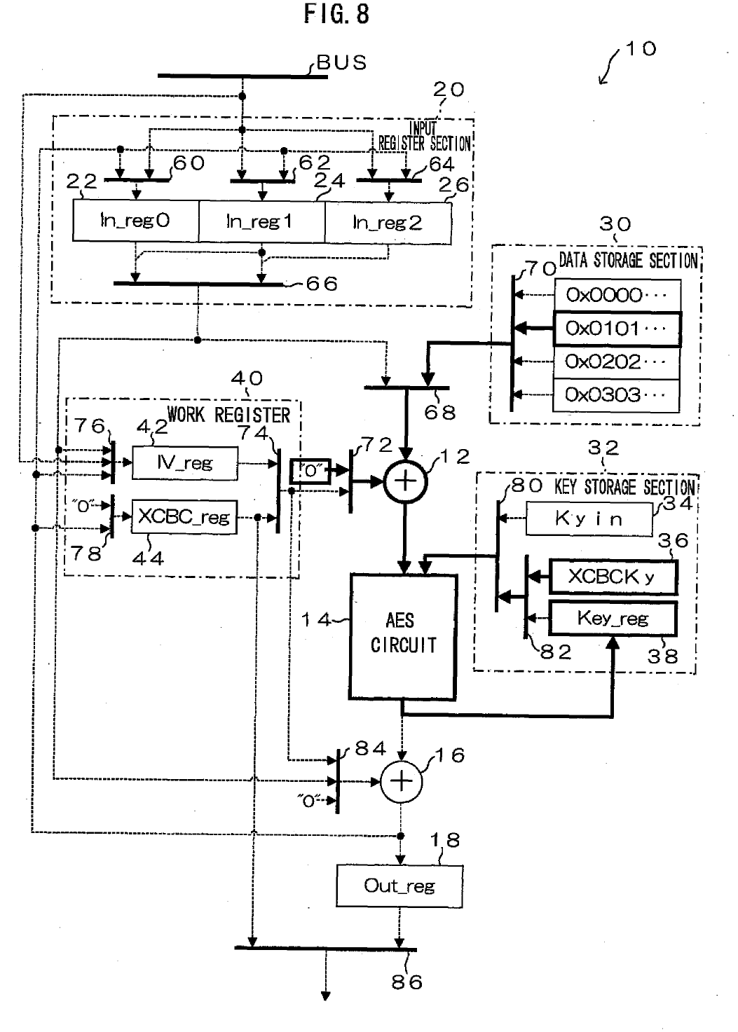

When generating and storing the work key K1, the operation of each selector in the information processing circuit 10 controls the data to flow in the circuit, as shown with the bold lines and outlines in FIG. 8. The data “0x0101 . . . ” stored in the data storage section 30 and the authorization key set in the XCBCKy 36 are inputted into the AES circuit 14. Accordingly, the output of the AES circuit 14 becomes the AES authorization key (“0x0101 . . . ”). The result of the encryption by the AES circuit 14 is stored in the Key_reg 38 as the work key K1.

At step 104, the selector 78 is operated so as to set the XCBC_reg 44 to “0” as the initialization processing. Then, the process moves to step 106.

At step 106, the first 24 bytes of data of the input packet are broken into three parts of 8 bytes and stored in each of the In_reg0, In_reg1, and In_reg2 of the input register section 20. Next, at step 108, the IV is stored in the IV_reg42. Then, the process moves to step 110.

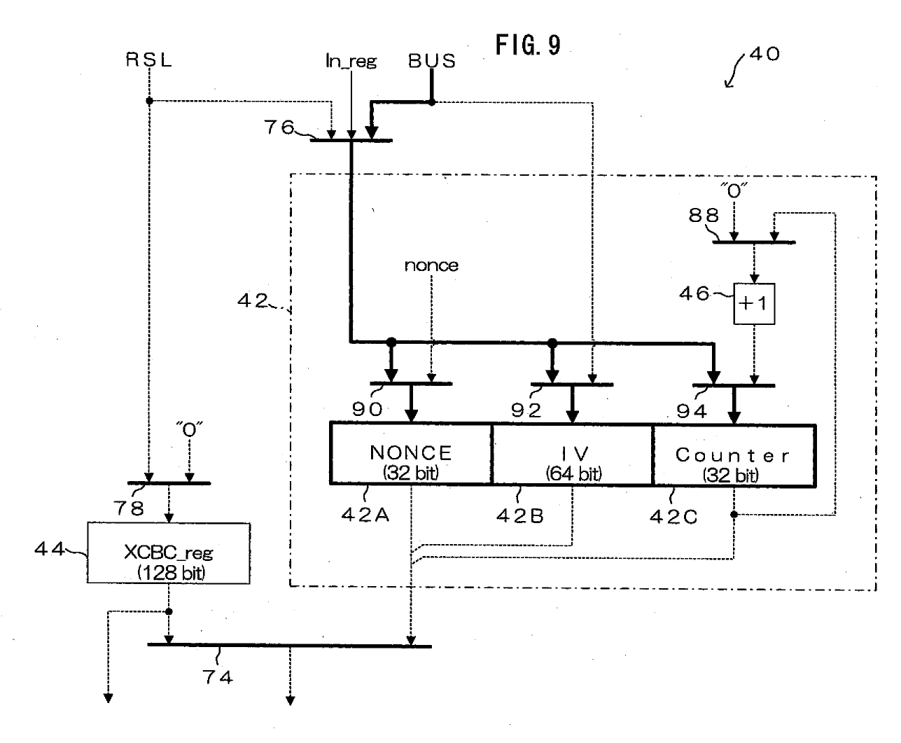

The flow of data in the work register 40 when storing the IV to IV_reg 42 is shown in FIG. 9. As shown in FIG. 9, the selector 76 is controlled to output the data inputted from the BUS and the IV is inputted to the IV_reg 42.

The selectors 90, 92, and 94 are controlled to output data outputted from the selector 76 to each block. Therefore, the first 32-bit portion of the IV inputted from the BUS is inputted into the NONCE block 42A. The next 64 bits are inputted to the IV block 42B and the remaining 32 bits are inputted into the counter block 42C.

At the next step 110, an authorization value creation process is performed on the data stored in the In_reg0 and In_reg1 of the input register section 20. Then, the process moves to step 112. With a packet that is encrypted with an AES-CBC mode, the ESP-HD52 and IV54 are added to the first 8 bytes. This portion is within the scope of authorization but not in the scope of encryption. Therefore, for this portion, only the authorization value creation process is performed, and the encryption process is not.

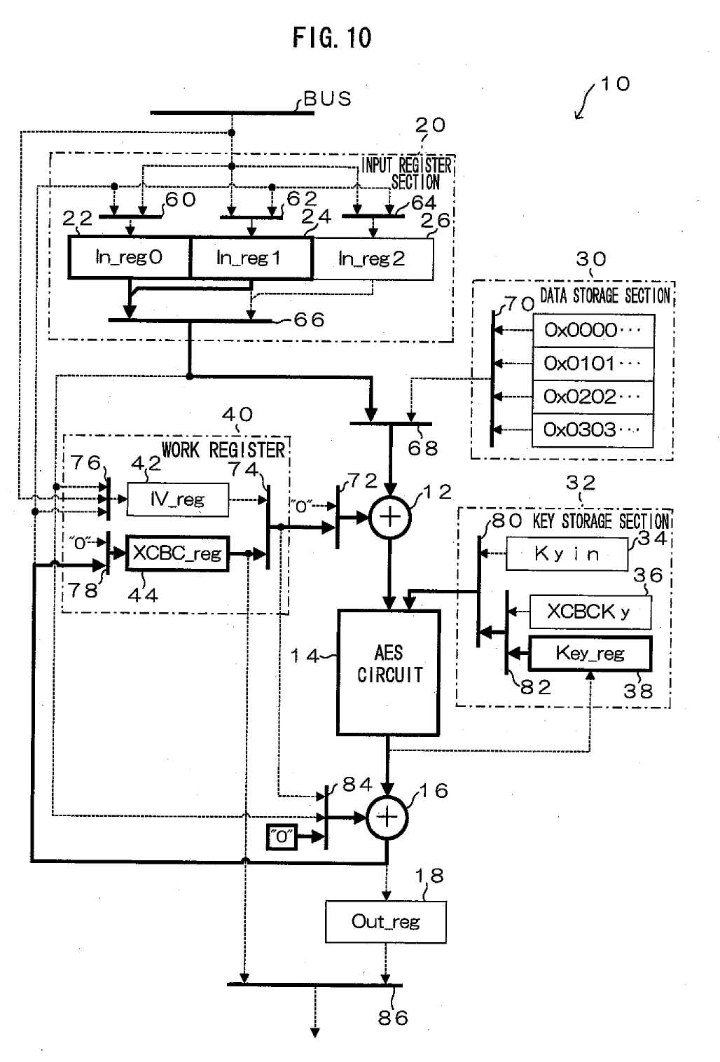

Here, the data flow in the information processing circuit 10 when executing the authorization value creation process is shown in FIG. 10 in bold lines and outlines. As shown in FIG. 10, the selector 66, selector 68, selector 72 and selector 74 are controlled so that the data stored the In_reg0 and In_reg1 and the data stored in the XCBC_reg 44 (at step 110, an initial value of “0”) are inputted to the first EXOR circuit 12.

The selector 80 and selector 82 are controlled to input the work key stored in the Key_reg 38 (at step 100, work key K1) into the AES circuit 14. Accordingly, the output of the first EXOR circuit 12 and the work key stored in the Key_reg 38 are inputted into the AES circuit 14.

At this point in time, the selector 84 is controlled to output “0” to not to perform calculation with the second EXOR circuit 16. Also, the selector 78 is controlled to store the output from the second EXOR circuit 16 in the XCBC_reg 44.

The authorization value creation process is calculated with the below formula (1), and is performed by storing the computation result in the XCBC_reg. Note that, the authorization value ICV is derived by repeating this processing until the end of the packet. For this reason, the computation result from this process for creating the authorization value is not output from the information processing circuit 10 until the processing has been performed to the end of the packet.

AESK1(XCBC_reg exor In_reg 0, 1) (1)

At step 112, the data stored in the input register section 20 are shifted by 16 bytes. Next, at step 114, the following packets are stored in each of the In_reg1 and In_reg2.

At the next step 116, encryption is performed on the data stored in the In_reg1 and In_reg2 of the input register section 20. Then the process moves to step 118.

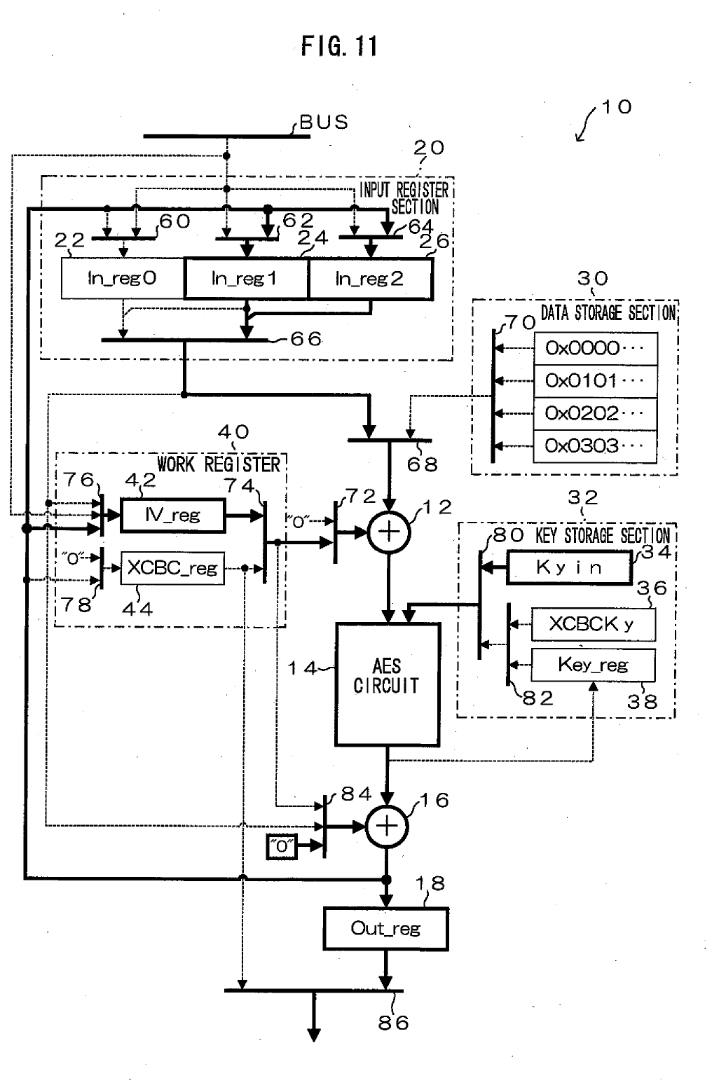

Here, the data flow in the information processing circuit 10 when performing encryption process is shown with bold lines and outlines in FIG. 11. As shown in FIG. 11, the selector 66, selector 68, selector 72 and selector 74 are controlled to input the data stored in the In_reg1 and In_reg2 and the data stored in the IV_reg 42 (becoming IV with the processing on the first block) to the first EXOR circuit 12. The selector 80 is controlled to input an encryption key stored in the Kyin 34 into the AES circuit 14. Accordingly, the output of the first EXOR circuit 12 and the encryption key stored in the Kyin 34 are inputted into the AES circuit 14. Further, at this point in time, the selector 84 is controlled to output “0” to not to perform computation with the second EXOR circuit 16.

Then the output from the second EXOR circuit 16 is stored in the output register section 18 and is outputted through the selector 86 from the information processing circuit 10.

The selector 76 is controlled to store the output from second EXOR circuit 16 in the IV_reg 42. Furthermore, the selectors 62 and 64 are also controlled to store the output from the second EXOR circuit 16 in the In_regs1, 2.

With the encryption process in the information processing circuit 10, the following formula (2) is performed and the computation result is outputted from the information processing circuit 10. With this and the encryption process, the computation result is stored in the IV_reg42, for use in encryption process of the next block. Further, the computation result (i.e., encrypted data) is stored in the In_regs 1, 2 for use in the authorization value creation process.

AESEncryption Key (IV_reg exor In_reg 1, 2) (2)

At the next step 118, an authorization value is made for the data stored in the In_reg0 and In_reg1. Then the process moves to step 120.

At step 120, it is determined whether the input packet is finished. When a negative determination is made, the process returns to step 112, and repeats the process from steps 112 to 118.

On the other hand, if an affirmative determination is made at step 120, the process moves to step 122, and the data stored in the input register section 20 are shifted by 16 bytes. At the next step 124, blank data is stored in the In_reg1.

At the next step 126, based on a standard of IPsec, blank data is inserted at the end of the input packet, and a process executes using the work key K3 when performing the final authorization value creation process.

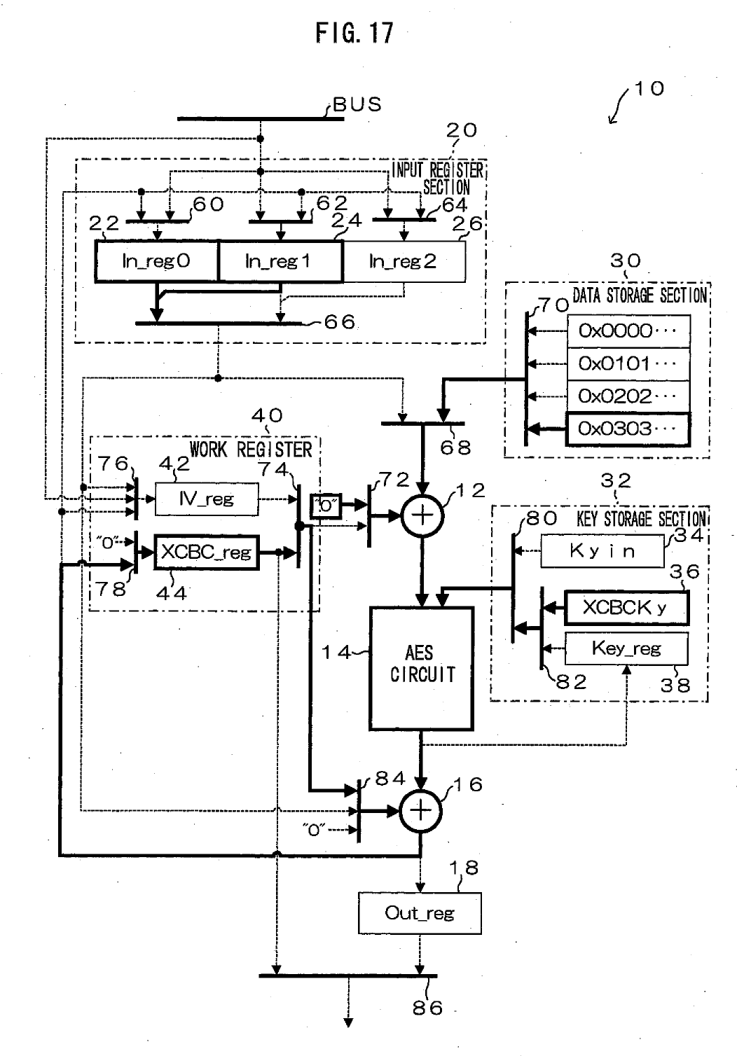

As shown in FIG. 17, with processing using the work key K3, the selector 70 is controlled so that “0x0303 . . . ” is outputted from the data storage section 30. With the processing using the work key K3, the selector 72 is controlled to output “0”. The selector 80 and the selector 82 are controlled to output the authorization key stored in the XCBCKy 36. Accordingly, the work key K3 (K3 is (AES authorization key “0x0303 . . . ”)) is generated.

Further, the selector 74 and selector 84 are controlled to output the data stored in the XCBC_reg 44. The selector 78 is also controlled to store the output of the second EXOR circuit 16 in the XCBC_reg 44.

In this manner, with the process using the work key K3, the result of the computation of the following formula (3) will be stored.

(AES authorization key (“0x0303 . . . ”)exor XCBC_reg) (3)

At the next step 128, the authorization value creation process is performed on the data stored in the In_reg0 and In_reg1 of the input register section 20 using the K1 stored in the Key_reg 38. Then, the process shifts to step 130. Note that, due to process of step 128, the result of the computation in the following formula (4) is stored in the XCBC_reg 44.

AESK1((AES authorization key (“0x0303 . . . ”)exor XCBC_reg)exor In_reg0,1) (4)

At step 130, the authorization value derived by the process of step 128 is outputted from the information processing circuit 10. Then, the encrypted authorization value creation process is completed. Note that, when outputting the authorization value, the selector 86 is controlled to output the authorization value stored in the XCBC_reg 44 from the information processing circuit 10 directly.

### [AES-CBC Mode Encryption/Authorization Value Creation]

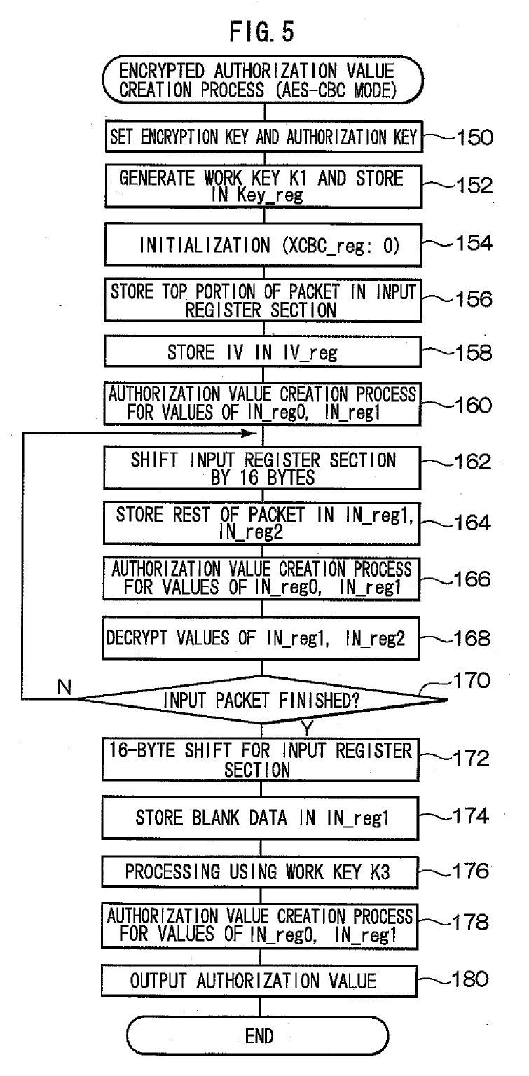

The flow of the process using the information processing circuit 10 when decrypting a packet encrypted in AES-CBC mode is shown in FIG. 5 as a flowchart. Hereafter, the operation of the decrypted authorization value creation process in AES-CBC mode of the information processing circuit 10 will be explained.

First, as shown in step 150, the encryption key and authorization key that should be applied to the decrypted authorization value creation process in AES-CBC mode are set. An encryption key and authorization key are set by negotiation between the IPsec device that has the information processing circuit 10 built in and the IPsec device being communicated with. The encryption key is inputted into the Kyin 34 and is set, and the authorization key is inputted into the KCBCKy 36 and is set.

At the next step 152, creating the work key K1 used in the authorization value creation (XCBC) process and storing the generated work key K1 to the Key_reg 38 are performed. Then, the process moves to step 154. Note that, here, the generation and storage of the work key K1 are the same as in the above-described encrypted authorization value process, and therefore the explanations thereon will be omitted (refer to FIG. 8).

At step 154, the selector 78 is operated to set “0” in the XCBC_reg 44 as the initialization process. Then, the process moves to step 156.

At step 156, the first 24 bytes of data of the input packet are stored in the In_reg0, In_reg1, and In_reg2 of the input register section 20, in parts of 8 bytes each. Also, at the next step 158, the IV is stored in the IV_reg 42. Then, the process shifts to step 160.

The storage of the IV to IV_reg 42 is the same as in the above-described process for creating the encrypted authorization value, and therefore the explanations thereon will be omitted (refer to FIG. 9).

At the next step 160, a process for creating an authorization value for the data stored in the In_reg0 and In_reg1 of the input register section 20 is executed, then the process moves to step 162. Note that, a packet encrypted in AES-CBC mode has an 8-byte ESP-HD 52 and a 16-byte IV 54 added to the front thereof. However, this portion is not in the scope of encryption but is in the scope of authorization. Therefore, to this portion, only the authorization value creation process is needed to be performed and decryption processing is not needed to be performed. Note that, the authorization value creation process is the same as the above-described encrypted authorization value creation process. Therefore the explanations thereon will be omitted (refer to FIG. 10). Also, as with the above-described encrypted authorization value creation process, the computation result from the authorization value creation process is not outputted from the information processing circuit 10, until processing has been performed to the end of the packet.

At step 162, the data stored in the input register section 20 are shifted by 16 bytes. At the next step 164, the respective continuations of the packet are stored in the In_reg1 and In_reg2.

At the next step 166, the authorization value creation process for the data stored in the In_reg0 and the In_reg1 of the input register section 20 is executed. Then, the process moves to step 168 and the process for decrypting the data stored in the In_reg1 and the In_reg2 of the input register section 20 is executed. Then, the process moves to step 170. The authorization value added to the input packet is derived based on the encrypted data so the authorization value creation process at the time of decryption involves performing computation of the authorization value based on the data prior to the decryption.

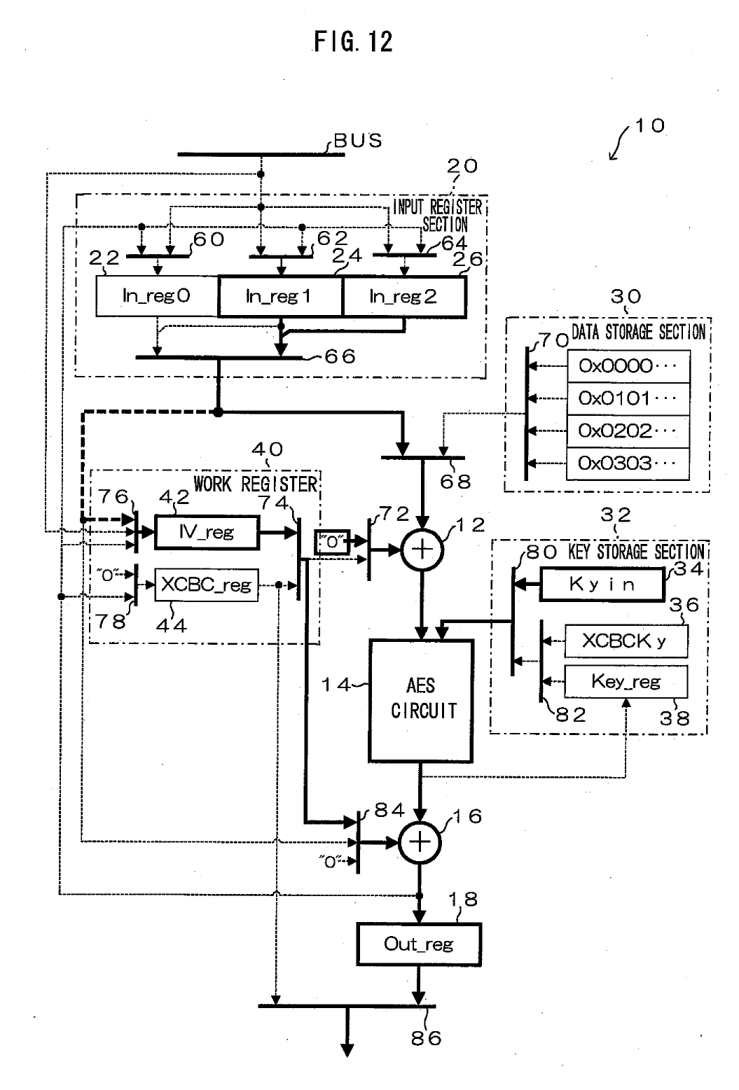

Here, the data flow in the information processing circuit 10 when carrying out the process for decryption is shown in FIG. 12 in bold lines and outlines. As shown in FIG. 12, the selector 66, selector 68, and selector 72 are controlled to store the data in the In_reg1, In_reg2, and “0” are inputted into the first EXOR circuit 12. Accordingly, the output of the first EXOR circuit 12 becomes the same as the data stored in the In_reg1 and In_reg2.

Also the selector 80 is controlled to input the encryption key stored in the Kyin 34 into the AES circuit 14. Accordingly, the data stored in the In_reg1 and In_reg2 and the encryption key stored in the Kyin 34 are inputted into the AES circuit 14.

Meanwhile, the selector 74 and selector 84 are controlled to input the data stored in the IV_reg 42 (with the processing on the first block, this becomes IV) into the second EXOR circuit 16.

Then the output from the second EXOR circuit 16 is stored in the output register section 18 and is outputted from the information processing circuit 10 through the selector 86.

Also, the selector 76 is controlled to store the data on which decryption processing was performed (i.e., the data stored at this point in time in the In_reg1 and In_reg2) in the IV_reg 42.

With the process for decryption, a computation is performed as shown in the below formula (5) with the information processing circuit 10 and the computation result is output from the information processing circuit 10. Accordingly, the data that was decrypted this time is stored in the IV_reg 42 to be used in the process for decryption of the next block.

(AES encryption key(In_reg1,2)exor IV_reg) (5)

At step 170, it is determined whether the input packet is finished. When a negative determination has been made, the process returns again to step 162 and the process from step 162 to 168 is repeated.

On the other hand, if an affirmative determination is made at step 170, the process moves to step 172 and the data stored in the input register section 20 are shifted by 16 bytes. At the next step 174, blank data is stored in the In_reg1.

At the next step 176, based on the standards of the IPsec, blank data is inserted in the end of the input packet, and process is performed by using the work key K3 when creating the last authorization value. This process that uses the work key K3 is the same as the process explained with the above-described encrypted authorization value creation process (refer to FIG. 17).

At the next step 178, an authorization value creation process using the K1 stored in the Key_reg 38 is performed on the data stored in the In_reg0 and In_reg1 of the input register section 20. Then, the process moves to step 180. Note that, with the process at step 178, the computation result shown in the above formula (4) is stored in the XCBC_reg 44.

At step 180, the authorization value derived by the process in step 178 is outputted from the information processing circuit 10, when the decrypted authorization value creation process is finished. Note that, when outputting the authorization value, the selector 86 is controlled to output the authorization value stored in the XCBC_reg 44 from the information processing circuit 10 directly.

### [AES-CTR Mode Encryption/Authorization Value Creation]

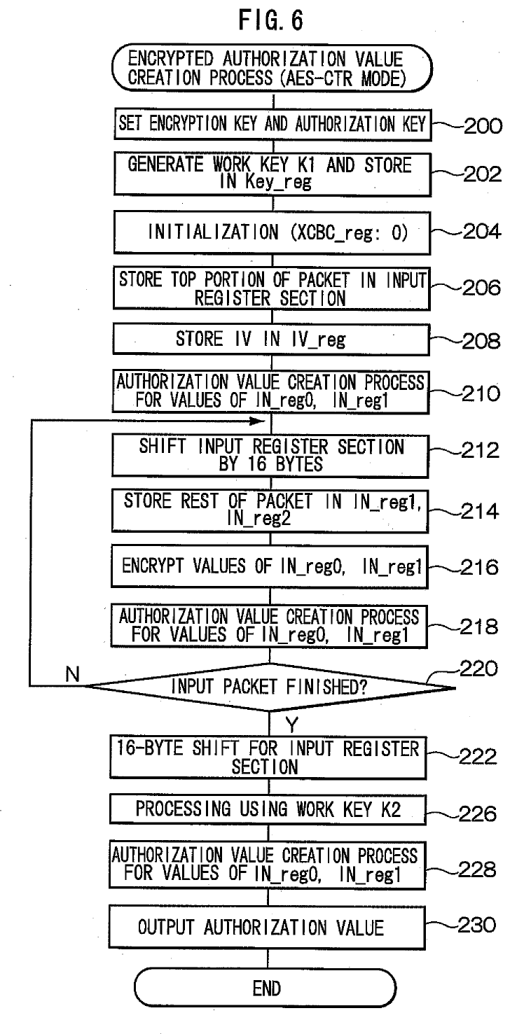

The flow of the process when encrypting a packet in AES-CTR mode using the information processing circuit 10 is shown in FIG. 6 as a flow chart. Hereafter, while referring to FIG. 6, the operation in the encrypted authorization value creation process in AES-CTR mode of the information processing circuit 10 according to the present embodiment will be explained.

First, as shown in step 200, an encryption key and authorization key that should be applied to the encrypted authorization value creation process in AES-CTR mode are set. An encryption key and authorization key are set by negotiation between the IPsec device that has the information processing circuit 10 built in and the IPsec device being communicated with. The encryption key is inputted into the Kyin 34 and is set, and the authorization key is inputted into the KCBCKy 36 and is set.

At the next step 202, creating the work key K1 used in the authorization value creation (XCBC) process and storing the generated work key K1 to the Key_reg 38 are performed. Then, the process moves to step 204. Note that, here, the generation and storage of the work key K1 are the same as in the above-described AES-CBC mode, and therefore the explanations thereon will be omitted (refer to FIG. 8).

At step 204, the selector 78 is operated to set “0” in the XCBC_reg 44 as the initialization process. Then the process moves to step 206.

At step 206, the first 24 bytes of data of the input packet are stored in the In_reg0, In_reg1, and In_reg2 of the input register section 20, in parts of 8 bytes each. Next at step 208, the IV is stored in the IV_reg 42. Then the process shifts to step 210.

Here, the data flow of the work register 40 when storing the IV in the IV_reg 42 in AES-CTR mode is shown in FIG. 13 in bold lines and outlines. As shown in FIG. 13, a random number nonce and the IV included in an input packet are input into the IV_reg 42. At this time, the selector 90 is controlled to input the random number nonce into the NONCE block 42A. In addition, the selector 92 is controlled to store the IV in the IV block 42B.

Meanwhile, the selector 88 is controlled to output “0” to the container 46. Also, the selector 94 is controlled to store the output of the count-up container 46 in the counter block 42C. The packet structure of the AES-CTR mode is such that the IV becomes 8 bytes (refer to FIG. 2B). With the AES-CTR mode, a random number nonce and a count value are added at the beginning and the end of the IV later, and these are used for encryption and decryption.

At next step 210, an authorization value creation process is executed for the data stored in the In_reg0 and In_reg1 of the input register section 20. Then, the process moves to step 212. Note that, the authorization value creation process is the same as in the above-described AES-CBC mode, and therefore the explanations thereon will be omitted (refer to FIG. 10).

Note that, the packet 50B encrypted with AES-CTR mode has an 8-byte ESP-HD 52 and an 8-byte IV 54 added to the front thereof. However, this portion is within the scope of authorization but is not in the scope of encryption. Accordingly, only the process for creating an authorization value is performed and processing for encryption is not performed.

At step 212, the data stored in the input register section 20 are shifted by 16 bytes. At the next step 214, the continuations of the packet are stored in each of the In_reg1 and In_reg2.

At the next step 216, processing for encrypting the data stored in the In_reg0 and the In_reg1 of the input register section 20 is performed. Then the process moves to step 218.

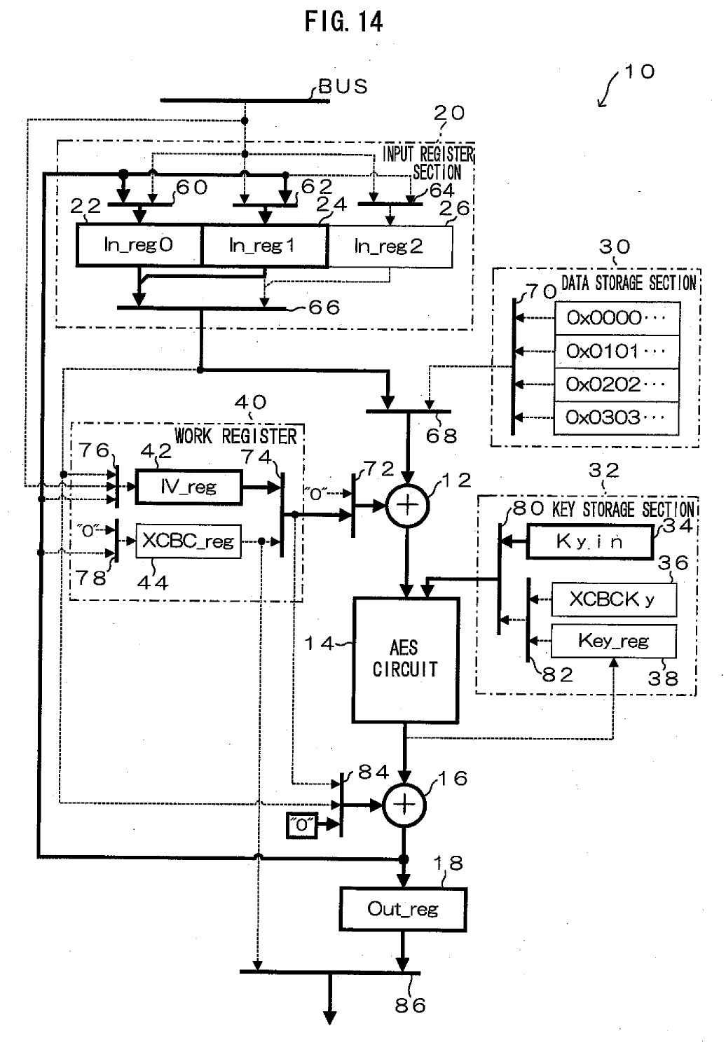

Here, the flow of data in the information processing circuit 10 when carrying out the process for encryption is shown in FIG. 14 in bold lines and outlines. As shown in FIG. 14, the selector 66, selector 68, selector 72, and selector 74 are controlled to input the data stored in the In_reg0 and In_reg1, and the data CTRn stored in the IV_reg 42 into the first EXOR circuit 12.

The selector 80 is also controlled to input the encryption key stored in the Kyin 34 into the AES circuit 14. Therefore, the output of the first EXOR circuit 12 and the encryption key stored in the Kyin 34 are inputted into the AES circuit 14.

Further, the selector 84 is controlled to output “0” in order to not to perform the computation by the second EXOR circuit 16 at this point in time.

Then the output from the second EXOR circuit 16 is stored in the output register section 18 and is outputted from the information processing circuit 10 through the selector 86.

Also, the selectors 60 and 62 are controlled to store the output from the second EXOR circuit 16 in the In_reg0 and In_reg1.

Accordingly, in the encryption process, the computation shown below in the following formula (6) is performed in the information processing circuit 10 and the computation result is outputted from the information processing circuit 10. Further, in the encryption process, the computation result (i.e., the encrypted data) is stored in the In_reg0 and In_reg1 for use in the authorization value creation process.

AES encryption key(IV_reg exor In_reg0, 1) (6)

Also, as shown in FIG. 15, when outputting the CTRn from the IV_reg 42, the data of the counter block 42C is also outputted to the count-up device 46 through the selector 88, for preparation to encrypt the next block. The count value incremented by the count-up container 46 is stored in the counter 42C through the selector 94. In other words, in AES-CTR mode, each block is encrypted using different CTRN for each block.

At the next step 218, the authorization value creation process for the data stored in the In_reg0 and In_reg1 of the input register section 20 is performed. Then the process moves to step 220.

At step 220, it is determined whether the input packet is finished. When a negative determination is made, the process returns to step 212 again and repeats the process from steps 212 to 218.

On the other hand, if an affirmative determination is made at step 220, the process moves to step 222 and the data stored in the input register section 20 are shifted by 16 bytes.

At the next step 226, based on a standard of IPsec, process is performed by using the work key K2 to create a last authorization value without adding blank data to the end of the input packet. The process using the work key K2 is the same as the process using the work key K3 as explained in the above-described AES-CBC mode (refer to FIG. 17), except the selector 70 is controlled to output “0x0202 . . . ”) from the data storage section 30.

At the next step 228, the an authorization value creation process using the K1 stored in the Key_reg 38 is performed to the data stored in the In_reg0 and In_reg1 of the input register section 20. Then the process moves to step 230. Note that, due to the processing at step 228, the result of the computation shown in the following formula (7) is stored in the XCBC_reg 44.

AESK1((AES authorization key(“0x0202 . . . ”)exor XCBC_reg)exor In_reg0,1) (7)

At step 230, the authorization value derived with the process of step 228 is outputted from the information processing circuit 10. Then the encrypted authorization value creation process is finished. Note that, when outputting the authorization value, the selector 86 is controlled to output the authorization value stored in the XCBC_reg 44 from the information processing circuit 10 directly.

### [AES-CTR Mode Decryption/Authorization Value Creation]

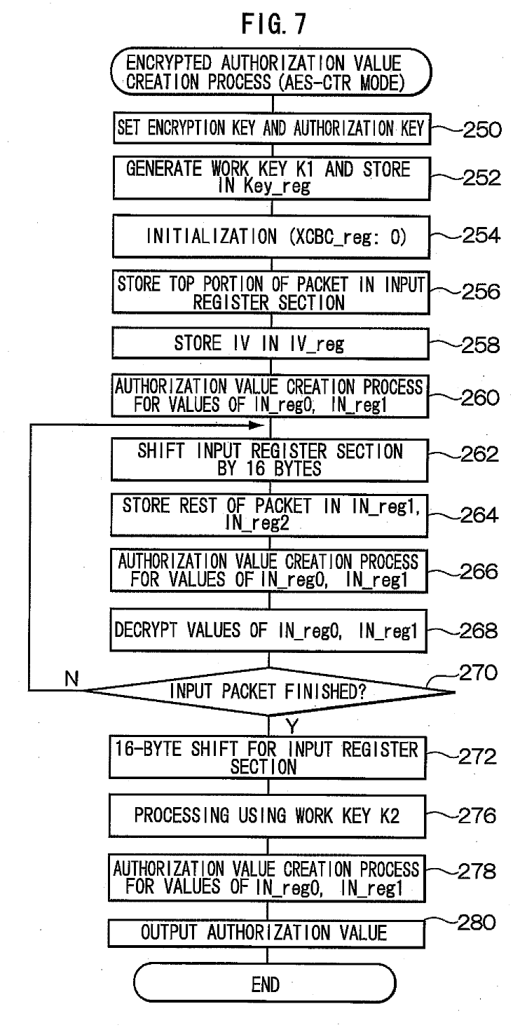

The flow of the process using the information processing circuit 10 when decrypting a packet encrypted in ABS-CTR mode is shown in FIG. 7 as a flow chart. Hereafter, while referring to FIG. 7, the operations in a decrypted authorization value creation process in the AES-CTR mode of the information processing circuit 10 according to the present embodiment will be explained.

First, as shown in step 250, the encryption key and authorization key that are applied to the decrypted authorization value creation process in AES-CTR mode are set. The encryption key and authorization key are determined based on negotiation between the IPsec device in which the information processing circuit 10 is built-in and the IPsec device to be communicated with. The encryption key is inputted and is set in the Kyin 34, and the authorization key is inputted and is set in the KCBCKy 36.

At the next step 252, generating the work key K1 used in the authorization value creation process and storing the generated work key K1 to the Key_reg 38 are performed. Then the process moves to step 154. Note that, generation and storage of the work key K1 here is the same as in the above-described encrypted authentication value creation process, and therefore the explanations thereon will be omitted (refer to FIG. 8).

At step 254, the selector 78 is operated to set “0” in the XCBC_reg 44 as the initialization process. Then, the process moves to step 256.

At step 256, the first 24 bytes of data of the input packet are stored in the In_reg0, In_reg1, and In_reg2 of the input register section 20 in parts of 8 bytes each. Next, at step 258, the IV is stored in the IV_reg 42 and Then the process moves to step 260.

Note that, the process of storing the IV to the IV_reg 42 is the same as in the above-described encrypted authentication value creation process, and therefore the explanations thereon will be omitted (refer to FIG. 13).

At the next step 260, an authorization value creation process for the data stored in the In_reg0 and In_reg1 of the input register section 20 is performed. The process then moves to step 262. Note that, a packet encrypted in AES-CTR mode has an 8-byte ESP-HD 52 and an 8-byte IV 54 added to the front thereof. However, while this portion is within the scope of being authorized, this portion is not within the scope for encryption. For this reason, only the process for creating an authorization value is performed and processing for decryption need not be performed. Note that, the authorization value creation process is the same as in the above-described process, and therefore the explanations thereon will be omitted (refer to FIG. 10). Further, as with the above-described encrypted authorization value creation process, the computation result from the process for the authorization value is not outputted from the information processing circuit 10 until the processing is performed up to the end of the packet.

At step 262, the data stored in the input register section 20 are shifted by 16 bytes. Next, at step 164, the following packets are each stored respectively in the In_reg1 and In_reg2.

At the next step 266, authorization value creation process for the data stored in the In_reg0 and In_reg1 of the input register section 20 is executed. Then, the process moves to step 268, and the decryption process for the data stored in the In_reg0 and In_reg1 of the input register section 20 is executed. The authorization value added to the input packet is derived based on the encrypted data, therefore the authorization value creation process at the time of decryption is computed based on the data prior to decryption. Then, the process moves to step 270.

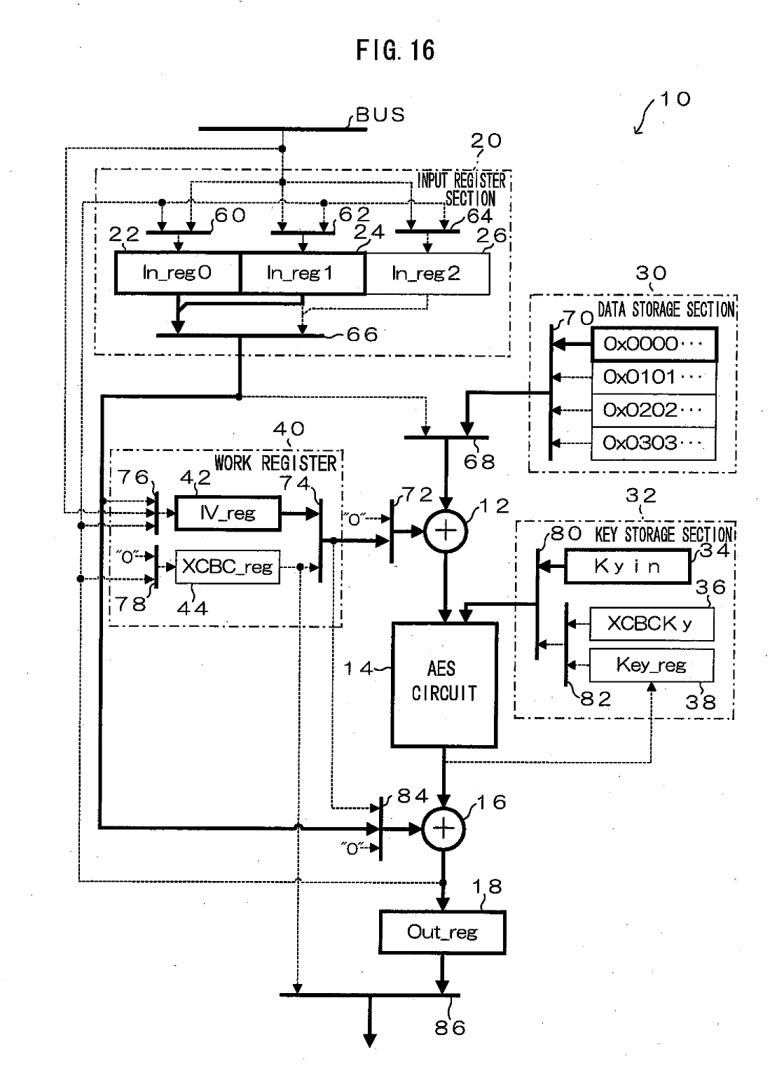

Here, the data flow in the information processing circuit 10 when carrying out the process for decryption is shown in FIG. 16 in bold lines and outlines. As shown in FIG. 16, the selector 66, selector 68, and selector 72 are controlled to input the data stored in the In_reg0 and In_reg1 and “0” to the first EXOR circuit 12. Accordingly, the output of the first EXOR circuit 12 becomes the same as the data stored in the In_reg0 and In_reg1.

Further, the selector 80 is controlled to input the encryption key stored in the Kyin 34 into the AES circuit 14. Therefore, the data stored in the In_reg0 and In_reg1 and the encryption key stored in the Kyin 34 are input into the AES circuit 14.

Meanwhile, the selector 74 and the selector 84 are controlled to input the data CTRn stored in the IV_reg 42 into the second EXOR circuit 16.

Then the output from the second EXOR circuit 16 is stored in the output register section 18 and output through the selector 86 from the information processing circuit 10.

Note that, at this time, the count value of the counter block 42C of IV_reg 42 is incremented, just as with the CTRn reading of the above-described encrypted authorization value creation process (refer to FIG. 15).

In other words, in the decryption process, the computation shown in the following formula (8) is performed with the information processing circuit 10 and the computation result is outputted from the information processing circuit 10. Further, in the decryption process, the count value of the IV_reg 42 is incremented in preparation for the process for decryption process of the next block.

(AES encrypting key(In_reg0,)exor IV_reg) (8)

At step 270, it is determined whether the input packet is finished. When a negative determination has been made, the process returns to step 262 and repeats the process from steps 262 to 268.

On the other hand, if an affirmative determination has been made at step 270, the process moves to step 272 and the data stored in the input register section 20 are shifted by 16 bytes.

At the next step 276, based on the standards of the IPsec, process using the work key K2 to create a final authorization value without adding blank data in the end of the input packet is performed. Note that, this processing that uses the work key K2 in the same manner as the process explained with the above-described an encrypted authorization value creation process, except the selector 70 is controlled to output “0x0202 . . . ” from the data storage section 30.

At the next step 278, the K1 stored in the Key_reg 38 is used and an authorization value creation process is performed on the data stored in the In_reg0 and In_reg1 of the input register section 20. Then the process moves to step 280. Note that, in the process of step 278, the computation result shown in the above formula (7) is stored in the XCBC_reg 44.

At step 280, the authorization value derived with the process of step 278 is outputted from the information processing circuit 10. Then the processing for creating a decrypted authorization value is finished. Note that, when outputting the authorization value, the selector 86 is controlled to output the authorization value stored in the XCBC_reg 44 from the information processing circuit 10 directly.

As explained above in the present embodiment, switching of the flow of data in the information processing circuit 10 is performed by controlling each selector. The authorization value creation process and the encryption process are executed alternately between two register sections of the input register section 20. In this manner, the encryption process and authorization value creation process can be executed without needing to increase the scale of the circuit.

In particular, when processing in AES-CBC mode, processing can be performed efficiently by staggering the registers of the input register section 20 on which the authorization value creation process and the encryption process are performed.

In addition, since the configuration of the IV_reg 42 includes registers that are divided, and a counter function is imparted to the IV_reg 42, the information processing circuit 10 of the present embodiment may be used with a AES-CTR mode.

Further, by providing the two EXOR circuits 12 and 16 respectively at the front and rear stages of the AES circuit 14, processing for encryption and decryption can be executed without utilizing a complicated configuration.

In addition, by providing the two EXOR circuits 12 and 16 respectively at the front and rear stages of the AES circuit 14, process that uses work keys K2 and K3 based on a IPsec standard can be executed, without needing to provide extra components, such as a register that stores the work keys K2 and K3. Note that, when executing the process for creating a work key using the first EXOR circuit 12 and AES circuit 14, EXOR computations can also be performed by using the second EXOR circuit 16. For this reason, the computation shown in formula (3) can be performed at one time and the processing time may be reduced.

Note that, the configuration of the information processing circuit 10 explained in the present embodiment (see FIGS. 1 and 3) and the flow of each type of processing (see FIGS. 4 through 7) are examples and may be appropriately adjusted within the scope of the present invention.

For example, in the above-described embodiment, an example was explained where the IV is obtained from the BUS and is stored in the IV_reg 42. However, since the IV is also inputted to the input register section 20, the information processing circuit 10 may be configured to read out the IV from the input register section 20 and to store the read IV data in the IV_reg 42.

In addition, in the above-described embodiment, an example was explained where the input register section 20 is provided with three 8-byte registers 22, 24, and 26. However, the input register section 20 may be configured to include 3m/2 registers (where m is an even number) that store one block of data by 1/m. For example, the input register section 20 can be configured to have six 4-byte registers.

What is claimed is:

1. An information processing apparatus that performs an encryption process and an authorization value creation process on input packet data, comprising:
a first EXOR circuit that outputs EXOR values for two pieces of data;
an encryption circuit that block encrypts the output of the EXOR circuit, in a predetermined block unit, based on preset key data;
an input register section including 3m/2 registers (where m is an even number) that stores the input packet data in 1/m block units; and
a control section that controls to continually execute the processes of:
an authorization value creation process that creates an authorization value for the input packet data stored in the first m registers of the input register using the first EXOR circuit and the encryption circuit;
an encryption process that encrypts the input packet data stored in the last m registers of the input register using the first EXOR circuit and the encryption circuit;
storing the encrypted data encrypted by the encryption process in the last m registers of the input register section;
shifting the data of the input register by m registers; and
storing continuation data of the input packet in the last m registers of the input register section.

2. The information processing apparatus of claim 1, further comprising a second EXOR circuit that outputs EXOR values for two pieces of data, wherein the control section further executes a decryption process that decrypts the encrypted input packet data by using the first EXOR circuit and the second EXOR circuit alternately.

3. The information processing apparatus of claim 2, wherein the second EXOR circuit is arranged at the output end of the encryption circuit.

4. An information processing apparatus that performs an encryption process and an authorization value creation process on input packet data, comprising:
a first EXOR circuit that outputs EXOR values for two pieces of data;
an encryption circuit that block encrypts the output of the EXOR circuit, in a predetermined block unit, based on preset key data;
an input register section that stores the input packet data in one-block portions; and
a control section that controls to continually execute the processes of:
an authorization value creation process that creates an authorization value for the input packet data stored in the input register using the first EXOR circuit and the encryption circuit;
an encryption process that encrypts the input packet data stored in the input register using the first EXOR circuit and the encryption circuit;
storing the encrypted data encrypted by the encryption process in the input register section; and
storing one-block portions of continuation data of the input packet in the input register.

5. The information processing apparatus of claim 4, further comprising a second EXOR circuit that outputs EXOR values for two pieces of data, wherein the control section further executes a decryption process that decrypts the encrypted input packet data by using the first EXOR circuit and the second EXOR circuit alternately.

6. The information processing apparatus of claim 5, wherein the second EXOR circuit is arranged at the output end of the encryption circuit.

7. An information processing apparatus that performs an encryption process and an authorization value creation process on input packet data, comprising:
a first EXOR circuit that outputs EXOR values for two pieces of data;
an encryption circuit that block encrypts the output of the EXOR circuit, in a 16-byte block unit, based on preset key data;
an input register section including three registers that store the input packet data, with one 8-byte portion per register; and
a control section that controls selectively to execute one of:
a CBC mode, in which the control section controls to continually execute:
an authorization value creation process that creates an authorization value for the input packet data stored in the first two registers of the input register using the first EXOR circuit and the encryption circuit;
an encryption process that encrypts the input packet data stored in the last two registers of the input register using the first EXOR circuit and the encryption circuit;
storing the encrypted data encrypted by the encryption process in the last two registers of the input register; and
shifting the data of the input register by a two-register portion and storing two-block portions of continuations of the input packet data in the last two registers; or
a CTR mode, in which the control section controls to continually execute:
an encryption process that encrypts the input packet data stored in the first two registers of the input register by using the first EXOR circuit and the encryption circuit;
storing the encrypted data encrypted by the encryption process in the first two registers of the input register section;
an authorization value creation process that creates an authorization value for the encrypted data stored in the first two registers of the input register by using the first EXOR circuit and the encryption circuit;
shifting the data of the input register by two register portions; and
storing continuation data of the input packet data in the last two register portions.

8. The information processing apparatus of claim 7, further comprising a second EXOR circuit that outputs EXOR values for two pieces of data, wherein the control section further executes a decryption process that decrypts encrypted input packet data by using the first EXOR circuit and the second EXOR circuit alternately.

9. The information processing apparatus of claim 8, wherein the second EXOR circuit is arranged at the output end of the encryption circuit.
